(19) United States
(12) Patent Application Publication
(10) Pub. No.: US 2017/0083177 A1
(43) Pub. Date: Mar. 23, 2017

(54) INFORMATION PROCESSING APPARATUS, INFORMATION PROCESSING METHOD, AND INFORMATION PROCESSING PROGRAM

(71) Applicant: NEC Corporation, Minato-ku, Tokyo (JP)

(72) Inventors: Masato KITADA, Tokyo (JP); Tatsushi YASUDA, Tokyo (JP); Satoru ISHII, Tokyo (JP); Kazuko MURAKOSHI, Tokyo (JP)

(73) Assignee: NEC Corporation, Minato-ku, Tokyo (JP)

(21) Appl. No.: 15/126,445

(22) PCT Filed: Dec. 22, 2014
(86) PCT No.: PCT/JP2014/083987

§ 371 Date: Sep. 15, 2016

(30) Foreign Application Priority Data
Mar. 20, 2014 (JP) 2014-059242

(51) Int. Cl. G06F 3/0482; G06F 3/0484; G06F 3/0481; G06F 3/0488

(52) U.S. Cl. CPC G06F 3/0482; G06F 3/04883; G06F 3/04845; G06F 3/04817

(57) ABSTRACT

An apparatus according to this invention is an information processing apparatus for making an actually selected target coincide with a target the user wants to select from a display document. The information processing apparatus includes a detector that detects a flick in an end portion of a selected range and a touch in a central portion of the selected range while the selected range is displayed in a display region of a touch panel, and a selected range controller that performs one of enlargement and reduction of the selected range based on the flick if the flick is detected in the end portion, and moves the selected range based on the touch and a drag of the selected range if the touch is detected in the central portion.

### TECHNICAL FIELD

The present invention relates to an information processing apparatus, an information processing method, and an information processing program.

### BACKGROUND ART

In the above technical field, patent literature 1 discloses a technique of selecting a paragraph, sentence, phrase, or word designated by the user by circling a designated region on the display screen of a smartphone or tablet.

### CITATION LIST

### Patent Literature

Patent literature 1: Japanese Patent Laid-Open No. 2013-186720

### SUMMARY OF THE INVENTION

### Technical Problem

In the technique described in the above literature, however, an actually selected target does not always coincide with a target the user wants to select from a display document. Especially, it is impossible to accurately select a document element such as a paragraph, sentence, phrase, or word included in a display document from the touch panel of a smartphone, a tablet, or the like.

The present invention enables to provide a technique of solving the above-described problem.

### Solution to Problem

One aspect of the present invention provides an information processing apparatus comprising:

a detector that detects a flick in an end portion of a selected range and a touch in a central portion of the selected range while the selected range is displayed in a display region of a touch panel; and

a selected range controller that performs one of enlargement and reduction of the selected range based on the flick, if the detector detects the flick in the end portion, and moves the selected range based on the touch and a drag of the selected range, if the detector detects the touch in the central portion.

Another aspect of the present invention provides an information processing method comprising:

detecting a flick in an end portion of a selected range or a touch in a central portion of the selected range while the selected range is displayed in a display region of a touch panel; and

performing one of enlargement and reduction of the selected range based on the flick if the flick is detected in the end portion, and moving the selected range based on the touch and a drag of the selected range if the touch is detected in the central portion.

Still other aspect of the present invention provides an information processing program for causing a computer to execute a method, comprising:

detecting a flick in an end portion of a selected range or a touch in a central portion of the selected range while the selected range is displayed in a display region of a touch panel; and

performing one of enlargement and reduction of the selected range based on the flick if the flick is detected in the end portion, and moving the selected range based on the touch and a drag of the selected range if the touch is detected in the central portion.

### Advantageous Effects of Invention

According to the present invention, it is possible to make an actually selected target coincide with a target the user wants to select from a display document.

### BRIEF DESCRIPTION OF DRAWINGS

FIG. 1 is a block diagram showing the arrangement of an information processing apparatus according to the first embodiment of the present invention;

FIG. 2A is a view for explaining change of a selected range in an information processing apparatus according to the second embodiment of the present invention;

FIG. 2B is a view for explaining change of the selected range in the information processing apparatus according to the second embodiment of the present invention;

FIG. 3 is a view for explaining movement of the selected range in the information processing apparatus according to the second embodiment of the present invention;

FIG. 4A is a view showing the outer appearance of the information processing apparatus according to the second embodiment of the present invention;

FIG. 4B is a block diagram showing the arrangement of the information processing apparatus according to the second embodiment of the present invention;

FIG. 5 is a block diagram showing the functional arrangement of a screen operation processor according to the second embodiment of the present invention;

FIG. 6 is a block diagram showing the functional arrangement of an operation acceptor according to the second embodiment of the present invention;

FIG. 7 is a block diagram showing the functional arrangement of an operation analyzer according to the second embodiment of the present invention;

FIG. 8A is a block diagram showing the functional arrangement of a user operation determiner according to the second embodiment of the present invention;

FIG. 8B is a table showing the structure of a selected range control table according to the second embodiment of the present invention;

FIG. 9 is a block diagram showing the functional arrangement of a display controller according to the second embodiment of the present invention;

FIG. 10 is a flowchart illustrating the procedure of screen operation processing by the information processing apparatus according to the second embodiment of the present invention;

FIG. 11A is a flowchart illustrating the procedure of flick analysis processing according to the second embodiment of the present invention;

FIG. 11B is a flowchart illustrating the procedure of selected range control processing according to the second embodiment of the present invention;

FIG. 12A is a block diagram showing the functional arrangement of a user operation determiner according to the third embodiment of the present invention;

FIG. 12B is a flowchart illustrating the procedure of screen operation processing by an information processing apparatus according to the third embodiment of the present invention;

FIG. 13 is a view for explaining display of selection icons in an information processing apparatus according to the fourth embodiment of the present invention;

FIG. 14A is a block diagram showing the functional arrangement of a user operation determiner according to the fourth embodiment of the present invention;

FIG. 14B is a table showing the structure of a selection icon table according to the fourth embodiment of the present invention;

FIG. 15 is a flowchart illustrating the procedure of screen operation processing by the information processing apparatus according to the fourth embodiment of the present invention;

FIG. 16 is a view for explaining change of selected range in an information processing apparatus according to the fifth embodiment of the present invention;

FIG. 17A is a block diagram showing the functional arrangement of a user operation determiner according to the fifth embodiment of the present invention;

FIG. 17B is a view showing the arrangement of a change movement unit storage unit according to the fifth embodiment of the present invention;

FIG. 17C is a view showing the arrangement of a change movement unit storage unit according to the fifth embodiment of the present invention; and

FIG. 18 is a table showing the structure of a change movement unit storage unit according to the sixth embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

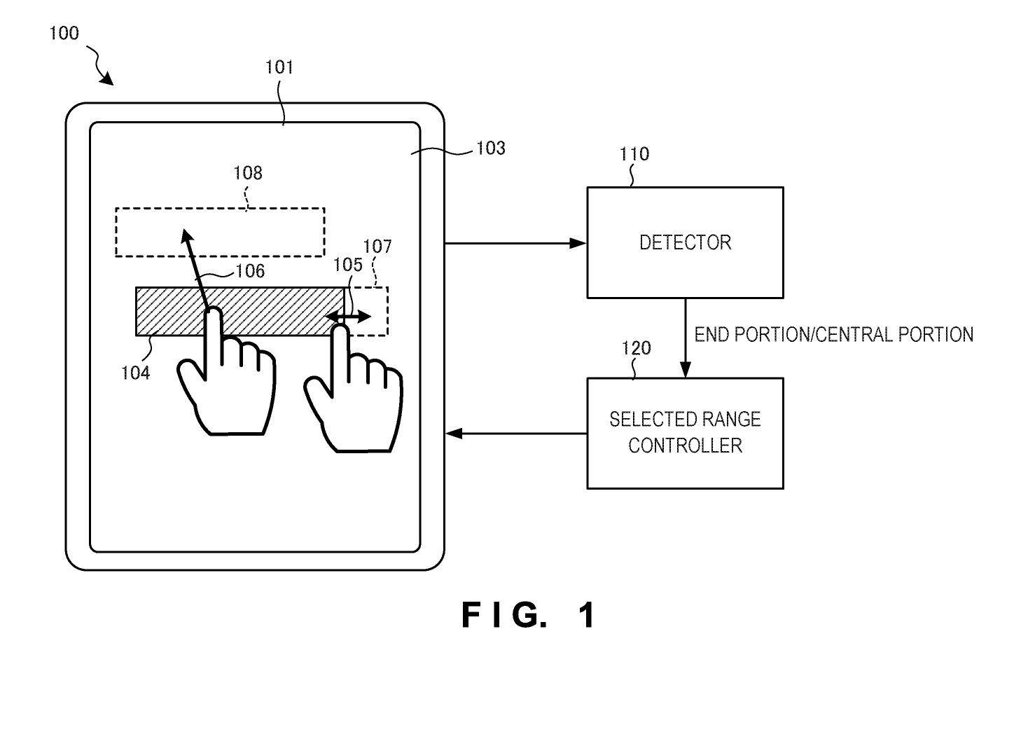

An information processing apparatus 100 according to the first embodiment of the present invention will be described with reference to FIG. 1. The information processing apparatus 100 is an apparatus for controlling a selected range on a display screen.

As shown in FIG. 1, the information processing apparatus 100 includes a detector 110 and a selected range controller 120. While a selected range 104 is displayed in a display region 103 of a touch panel 101, the detector 110 detects a flick 105 in an end portion of the selected range 104 or a touch in the central portion of the selected range 104. If the flick 105 is detected in the end portion, the selected range controller 120 performs enlargement 107 or reduction of the selected range 104 based on the flick 105. If the touch is detected in the central portion, the selected range controller 120 moves the selected range 104 based on the touch and a drag 106 (108).

For example, by the flick in the end portion, a character, word, phrase, sentence, paragraph, or the like can be selected as a unit of enlargement or reduction. By a long touch in the central portion, a copy or grip operation is performed or a selection icon is displayed.

According to the present invention, since a selected range can be adjusted by a simple operation, it is possible to make an actually selected target coincide with a target the user wants to select from a display document.

### Second Embodiment

An information processing apparatus according to the second embodiment of the present invention will be described next. The information processing apparatus according to this embodiment enlarges or reduces a selected range in accordance with the direction of a flick in one of the two end portions of the selected range, and also moves the selected range in accordance with a touch and drag in the central portion of the selected range. The enlarged or reduced amount of the selected range is one character in this embodiment, or a predetermined number of characters.

<<Overview of Processing>>

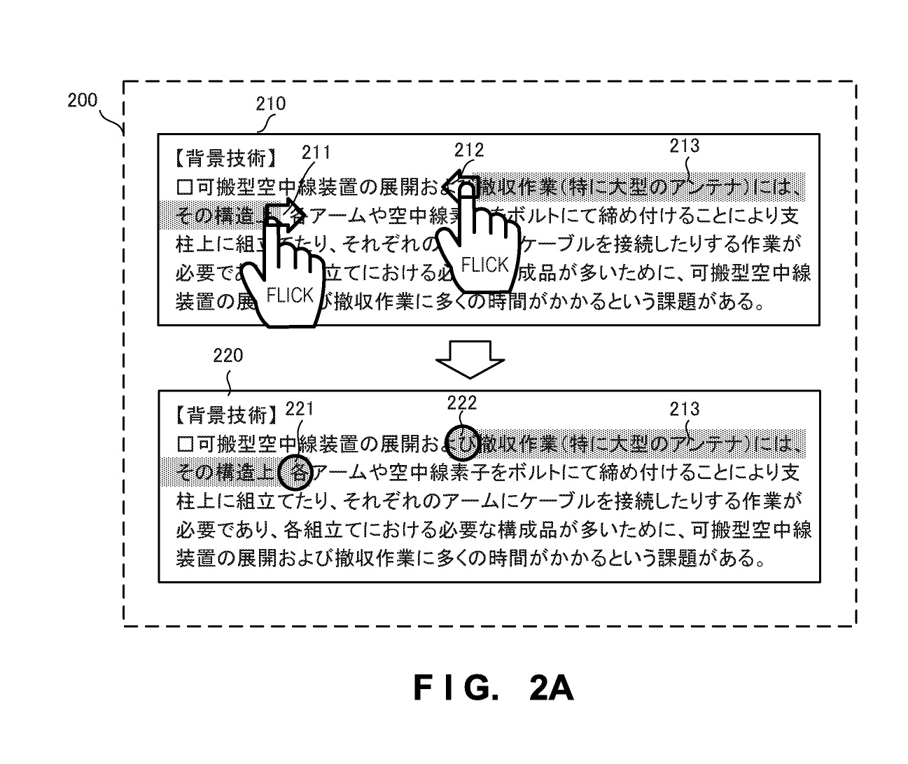

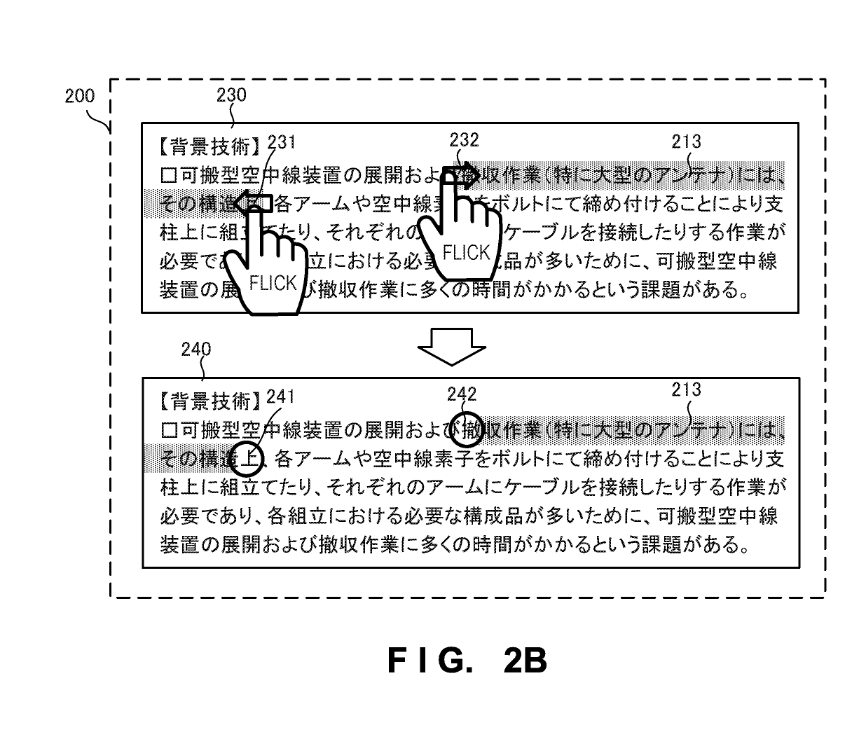

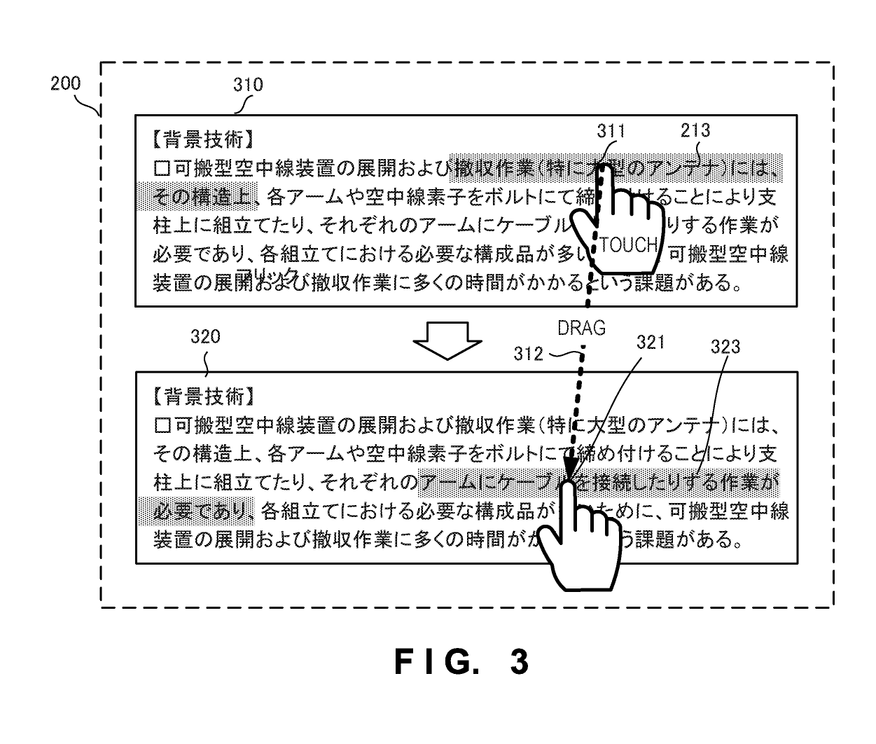

An overview of control of a selected range by the information processing apparatus according to this embodiment will be described with reference to FIGS. 2A to 3.

(Change of Selected Range)

FIG. 2A is a view for explaining change of a selected range in an information processing apparatus 200 according to this embodiment.

The user performs a flick operation 211 rightward at the end of a selected range 213 (the right end of a character string) on a screen 210. As a result, the end of the selected range 213 is enlarged rightward by one character 221, as shown in a view 220.

On the other hand, the user performs a flick operation 212 leftward at the top of the selected range 213 (the left end of the character string) on the screen 210. As a result, the top of the selected range 213 is enlarged leftward by one character 222, as shown in the view 220.

FIG. 2B is a view for explaining change of the selected range in the information processing apparatus 200 according to this embodiment.

The user performs a flick operation 231 leftward at the end of the selected range 213 on a screen 230. As a result, the end of the selected range 213 is reduced leftward by one character 241, as shown in a view 240.

On the other hand, the user performs a flick operation 232 rightward at the top of the selected range 213 on the screen 230. As a result, the top of the selected range 213 is reduced rightward by one character 242, as shown in the view 240.

(Movement of Selected Range)

FIG. 3 is a view for explaining movement of the selected range in the information processing apparatus 200 according to this embodiment.

The user performs a touch operation 311 in the central portion of the selected range 213 on a screen 310. Subsequently, the user performs a drag operation 312. As a result, the selected range 213 is moved to a selected range 323, as shown in a view 320.

<<Information Processing Apparatus>>

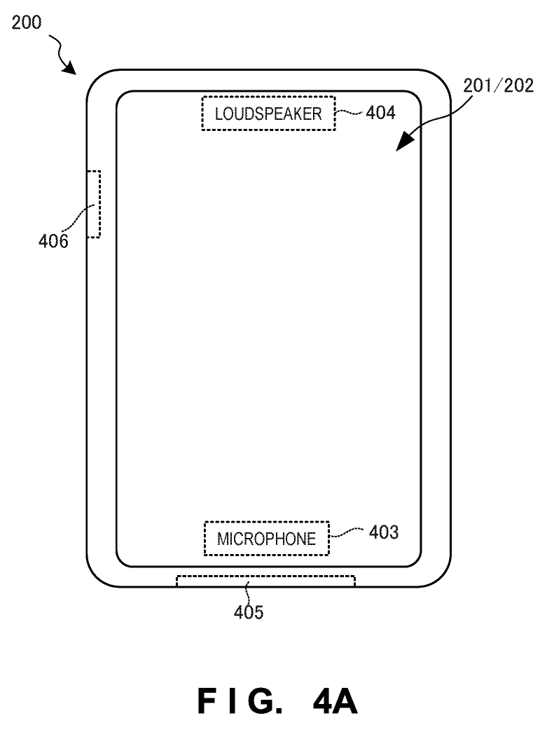

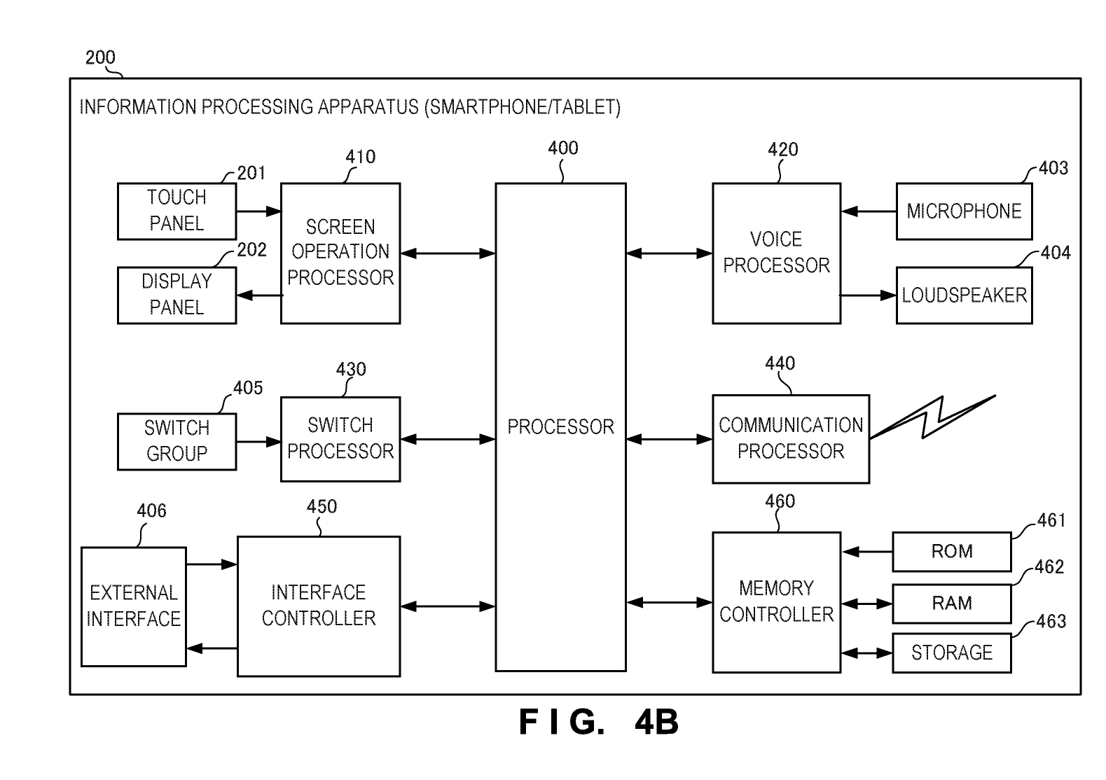

FIG. 4A is a view showing the outer appearance of the information processing apparatus 200 according to this embodiment. Note that FIG. 4A shows a portable terminal using a touch panel, such as a smartphone or tablet. However, the information processing apparatus is not limited to the smartphone, the tablet, or the like, and any information processing apparatus using a touch panel can be adopted.

In the information processing apparatus 200, a touch panel 201 and a display panel 202 function as an operation unit and a display unit, respectively. The information processing apparatus 200 includes a microphone 403 and a loudspeaker 404 as a voice input/output function. The information processing apparatus 200 also includes a switch group 405 including a power switch. Furthermore, the information processing apparatus 200 includes an external interface 406 used for external input/output device connection and communication connection.

(Functional Arrangement of Information Processing Apparatus)

FIG. 4B is a block diagram showing the arrangement of the information processing apparatus 200 according to this embodiment. Note that FIG. 4B shows the basic arrangement of the portable terminal using the touch panel, such as a smartphone or tablet. The present invention, however, is not limited to this. Each component shown in FIG. 4B may be implemented by a single hardware component, software by including a proprietary processor to execute a program, or firmware by combining hardware and software. Each component shown in FIG. 4B is separated from other components to independently implement its function. In fact, however, each component is implemented by a combination of multilayer controls from bottom layer control by basic hardware and OS (Operating System) and input/output control to top layer control by an application program.

A processor 400 includes at least one CPU (Central Processing Unit), and controls the overall information processing apparatus 200. Note that the processor 400 desirably incorporates a unique memory. A screen operation processor 410 is a component for performing processing according to this embodiment. The screen operation processor 410 accepts a user operation input from the touch panel 201, changes a display screen in correspondence with the user operation input, and displays the screen on the display panel 202. Note that the screen operation processor 410 may be implemented by executing an associated program by the processor 400 but an independent screen operation processor is desirably provided. A voice processor 420 processes a voice input from the microphone 403 to, for example, transmit the voice input via a communication processor 440 or process a user voice instruction changed to a user operation input from the touch panel 201. The voice processor 420 generates a notification/warning to the user, a video reproduction voice, or the like, and outputs a voice from the loudspeaker. The voice processor 420 is also desirably provided with a voice processing processor independent of the processor 400.

A switch processor 430 executes processing based on a switch input from the switch group 405. The communication processor 440 transmits/receives data via a network. An interface controller 450 controls data input/output to/from an input/output device connected via the external interface 406. The communication processor 440 is also desirably provided with a voice processing processor independent of the processor 400. For example, a memory controller 460 controls exchange of data and programs between the processor 400 and a ROM (Read Only Memory) 461 which is formed by a flash memory and the like, RAM (Random Access Memory) 462, and storage 463. The memory controller 460 is also desirably provided with a voice processing processor independent of the processor 400.

The screen operation processor 410 according to this embodiment will be described in more detail below.

(Screen Operation Processor)

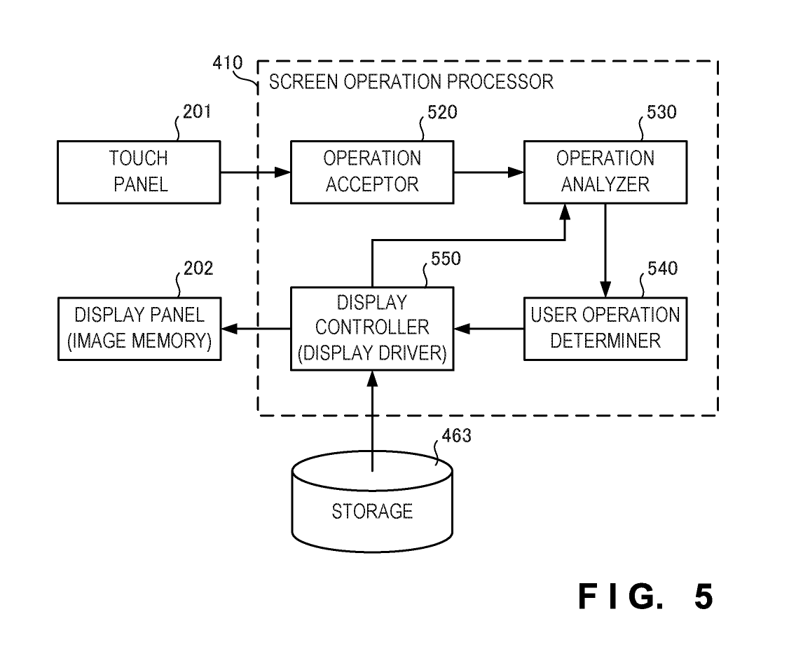

FIG. 5 is a block diagram showing the functional arrangement of the screen operation processor 410 according to this embodiment.

The screen operation processor 410 includes an operation acceptor 520, an operation analyzer 530, a user operation determiner 540, and a display controller 550. The operation acceptor 520 accepts a user operation from the touch panel 201, and acquires a touch position and an operation. The operation analyzer 530 analyzes operation contents in consideration of information of the display screen based on the user operation and position accepted by the operation acceptor 520. In this embodiment, the operation analyzer 530 especially detects the setting operation of the selected range and a touch operation on an icon. Based on the operation contents analyzed by the operation analyzer 530, the user operation determiner 540 estimates an operation desired by the user. In this embodiment, the user operation determiner 540 controls enlargement or reduction of the selected range in the case of a flick in one of the two end portions of the selected range, and controls movement of the selected range in the case of a touch and drag in the central portion of the selected range. The display controller 550 includes a display driver. The display controller 550 reads out a content including a document from the storage 463, and controls screen display on the display panel 202 in accordance with the determination result of the user operation determiner 540. Under the control of the display controller 550, the operation desired by the user can be implemented on the display screen.

Note that the functional components shown in FIG. 5 may be implemented by the processing of the processor of the screen operation processor 410, or some functional components may be processed by a proprietary processor to increase the processing speed. Each functional component shown in FIG. 5 is limited to the operation of the screen operation processor 410 but may exchange data with other components of the information processing apparatus 200 shown in FIG. 4B.

(Operation Acceptor)

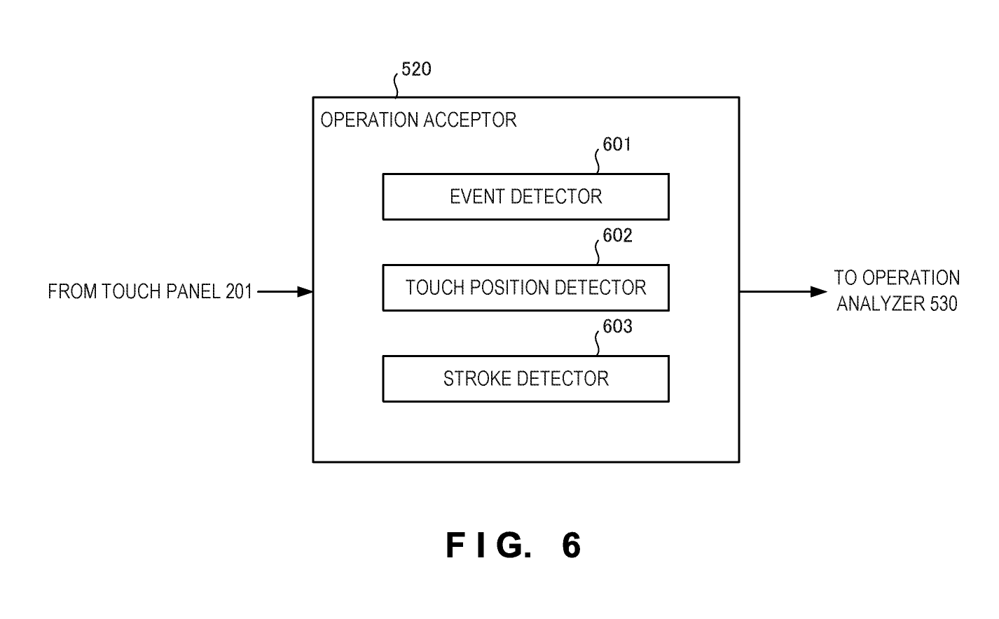

FIG. 6 is a block diagram showing the functional arrangement of the operation acceptor 520 according to this embodiment. The operation acceptor 520 accepts a user operation from the touch panel 201, and acquires a touch position and an operation.

The operation acceptor 520 includes an event detector 601, a touch position detector 602, and a stroke detector 603. The event detector 601 detects the start of some operation from the user on the touch panel 201, and starts accepting operation data. The touch position detector 602 detects position coordinates on the touch panel 201 touched by a user's finger. The stroke detector 603 detects a stroke as a locus from the start point of a user touch to its end point based on a temporal change of the touch.

(Operation Analyzer)

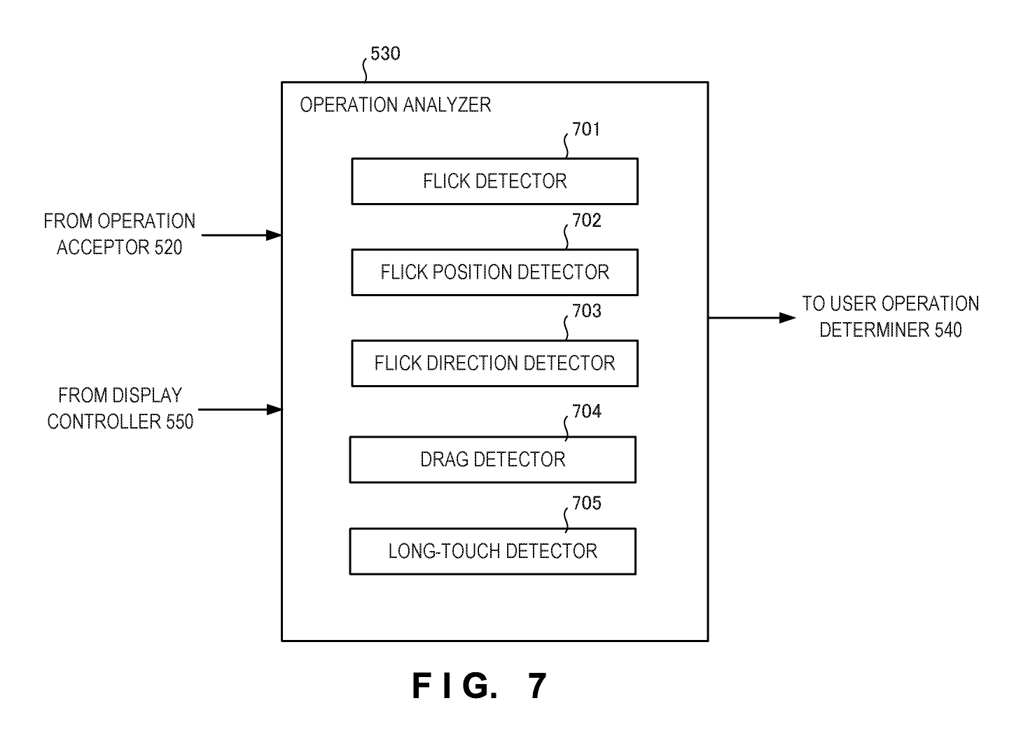

FIG. 7 is a block diagram showing the functional arrangement of the operation analyzer 530 according to this embodiment. The operation analyzer 530 analyzes operation contents in consideration of the information of the display screen based on the user operation and position accepted by the operation acceptor 520.

The operation analyzer 530 includes a flick detector 701, a flick position detector 702, a flick direction detector 703, a drag detector 704, and a long-touch detector 705. Based on touch position information and stroke information detected by the operation acceptor 520, the flick detector 701 detects that a flick operation has been performed. Based on the touch position information detected by the operation acceptor 520, the flick position detector 702 detects a position at which the flock operation has been performed. Based on the stroke information detected by the operation acceptor 520, the flick direction detector 703 detects the direction of the flick operation. Based on the touch position information and stroke information detected by the operation acceptor 520, the drag detector 704 detects that a drag operation has been performed. Based on the touch position information detected by the operation acceptor 520, the long-touch detector 705 detects a long-touch operation from a touch time at the same position. If the touch time is equal to or longer than a predetermined time, a long touch is determined.

(User Operation Determiner)

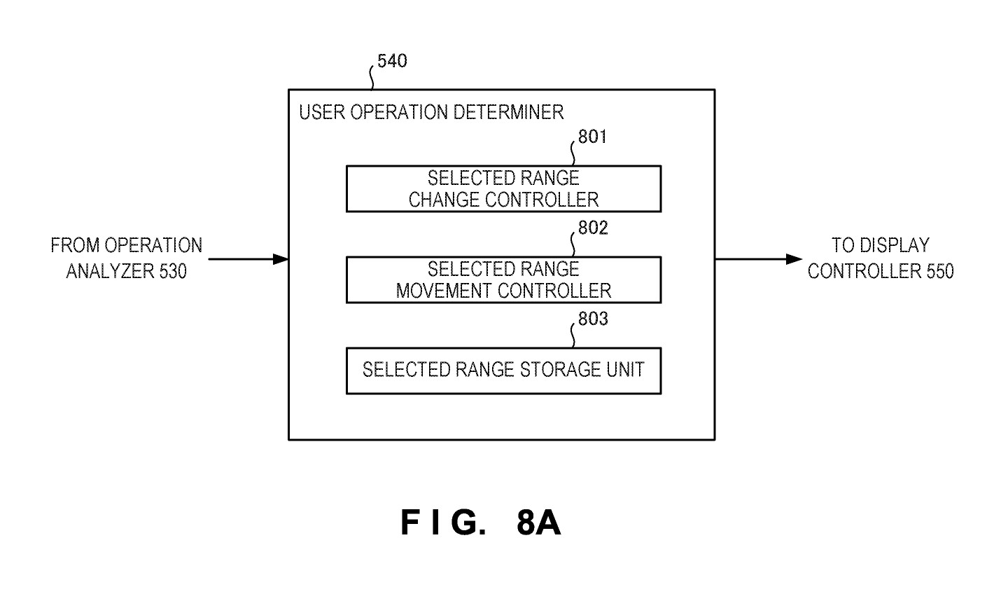

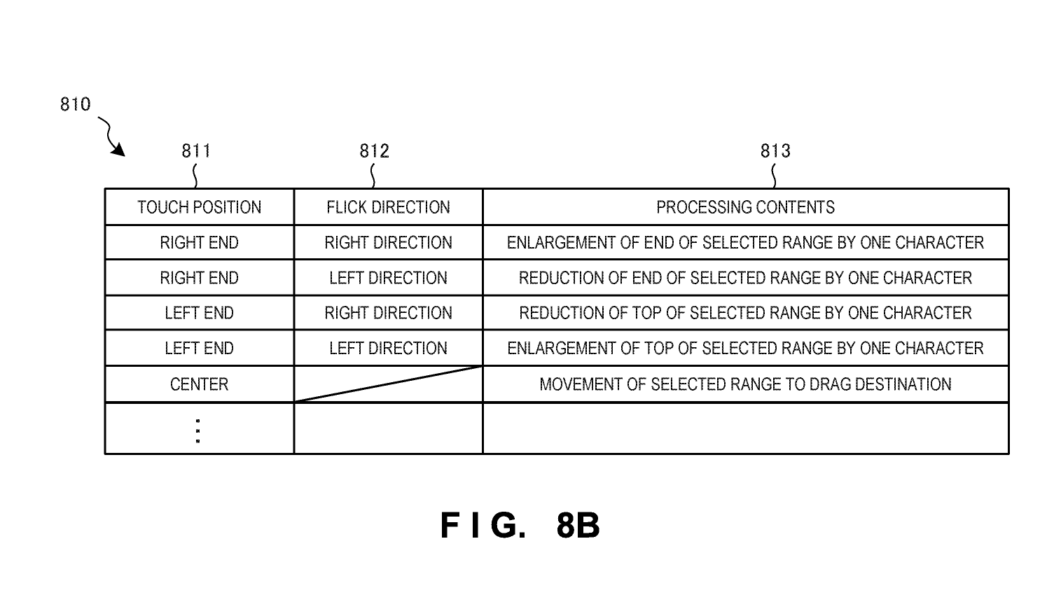

FIG. 8A is a block diagram showing the functional arrangement of the user operation determiner 540 according to this embodiment. Based on the operation contents analyzed by the operation analyzer 530, the user operation determiner 540 determines an operation desired by the user. In this embodiment, the user operation determiner 540 controls enlargement or reduction of the selected range in the case of a flick in one of the two end portions of the selected range, and controls movement of the selected range in the case of a touch and drag in the central portion of the selected range.

The user operation determiner 540 includes a selected range change controller 801, a selected range movement controller 802, and a selected range storage unit 803. The selected range change controller 801 controls enlargement or reduction of the selected range based on the flick position and flick direction of the operation analyzer 530. The selected range movement controller 802 controls movement of the selected range based on the touch position of the operation acceptor 520 and the drag detection of the operation analyzer 530. The selected range storage unit 803 stores the current selected range, as needed, and reflects it to display on the display panel 202.

FIG. 8B is a table showing the structure of a selected range control table 810 according to this embodiment. The selected range control table 810 is used by the selected range change controller 801 and selected range movement controller 802 to control the selected range stored in the selected range storage unit 803.

The selected range control table 810 stores processing contents 813 in association with a touch position 811 within the selected range and a flick direction 812 in the case of a flick operation. Note that if the touch position 811 falls within the central portion of the selected range, the selected range is moved to a drag destination as the processing contents 813. In determination of whether the touch position 811 is at the end of the selected range or falls within the central portion of the selected range, a portion having a predetermined length or shorter from one of the two end portions of the selected range is set as an “end”.

(Display Controller)

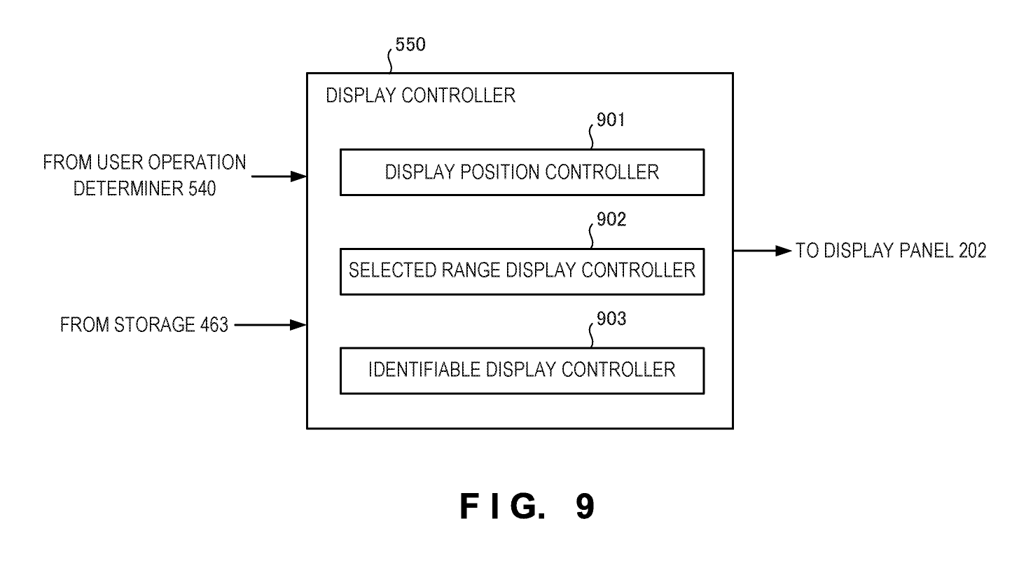

FIG. 9 is a block diagram showing the functional arrangement of the display controller 550 according to this embodiment. The display controller 550 reads out a content including a document from the storage 463, and controls screen display on the display panel 202 in accordance with the determination result of the user operation determiner 540.

The display controller 550 includes a display position controller 901, a selected range display controller 902, and an identifiable display controller 903. The display position controller 901 controls a position of the content read out from the storage 463 to be displayed. In this embodiment, the display position controller 901 controls the display position of the document. The selected range display controller 902 controls the selected range based on a flick and a touch and drag operation by the user. The identifiable display controller 903 controls to identifiably display the selected range of the document on the display screen.

<<Procedure of Screen Operation Processing>>

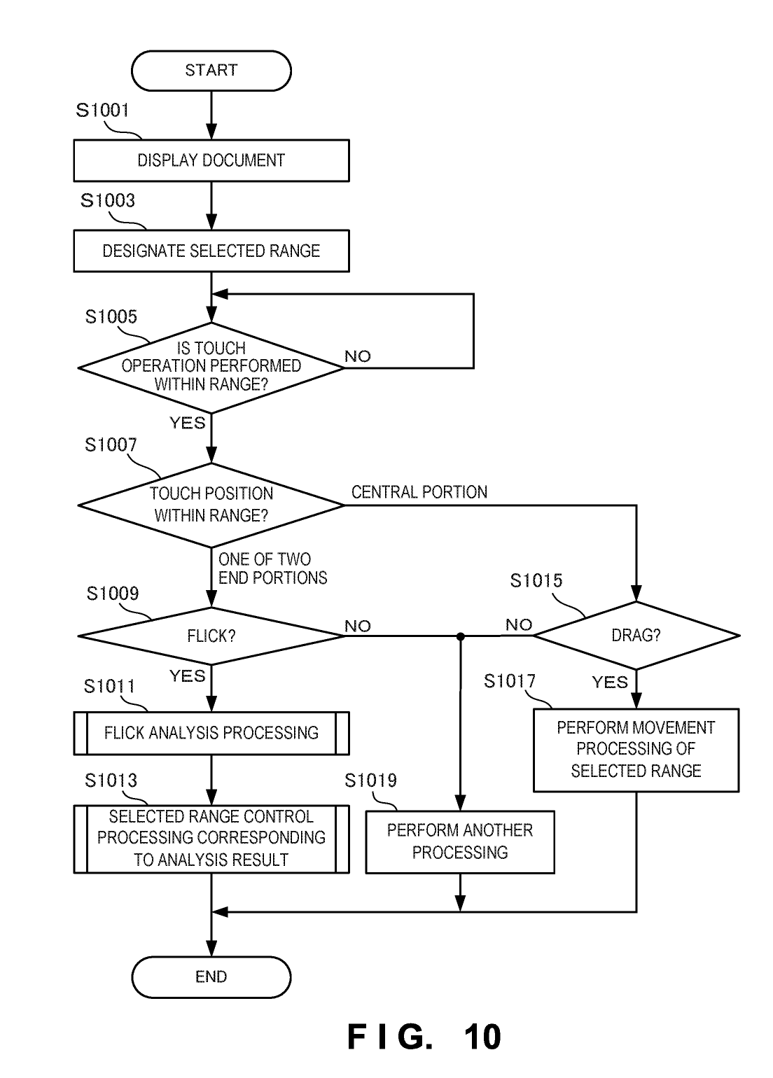

FIG. 10 is a flowchart illustrating the procedure of screen operation processing by the information processing apparatus 200 according to this embodiment. This flowchart implements the respective functional components of the screen operation processor 410 when executed by the processor 400 or the CPU of the screen operation processor 410. A case in which the CPU of the screen operation processor 410 executes the flowchart will be described.

In step S1001, the screen operation processor 410 displays a predetermined portion of a document designated, by the user, to be displayed. In step S1003, the screen operation processor 410 identifies and displays a selected range in the display document designated by the user. In step S1005, the screen operation processor 410 monitors whether a user's finger touches the selected range. If a touch by the finger is detected, the screen operation processor 410 determines the touch position of the finger within the selected range in step S1007.

If it is determined that the determined position falls within one of the two end portions of the selected range, the screen operation processor 410 determines in step S1009 whether the user operation is a flick. If it is determined that the user operation is a flick, the screen operation processor 410 executes, in step S1011, flick analysis processing of selecting processing contents based on the flick operation. In step S1013, the screen operation processor 410 executes selected range control processing corresponding to an analysis result. If it is determined that the user operation is not a flick, the screen operation processor 410 performs another processing in step S1019.

On the other hand, if it is determined in the touch position determination processing in step S1007 that the touch position falls within the central portion of the selected range, the screen operation processor 410 determines in step S1015 whether the user operation is a drag operation. If it is determined that the user operation is a drag operation, the screen operation processor 410 executes, in step S1017, processing of moving the selected range to a drag destination.

(Flick Analysis Processing)

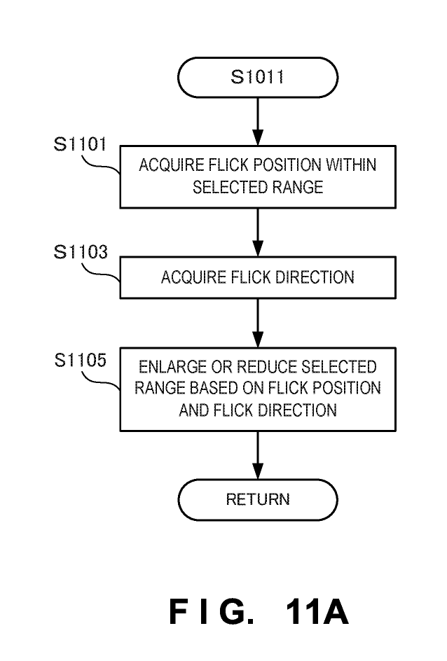

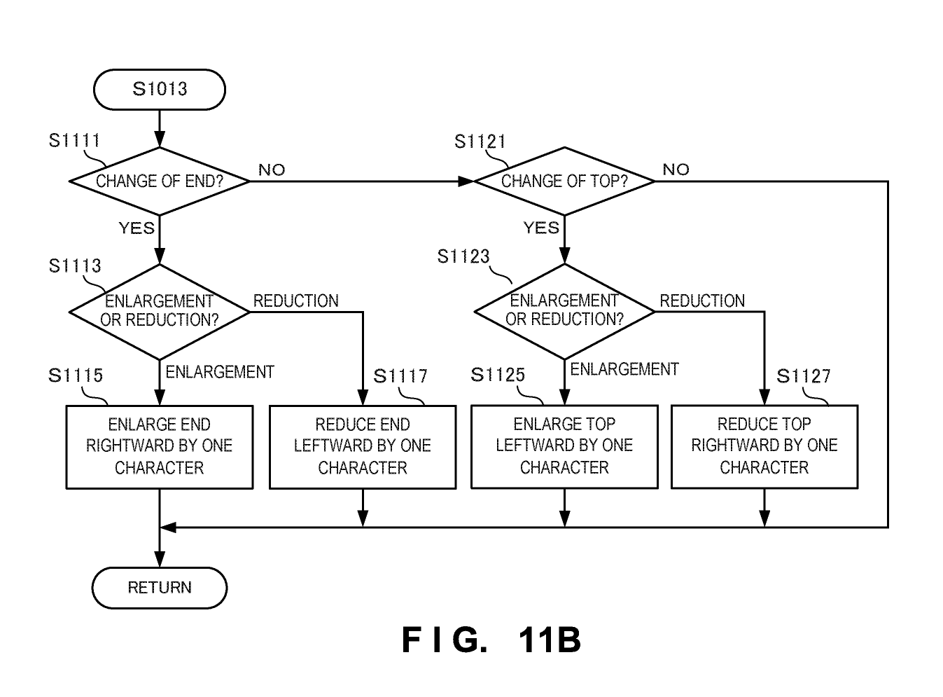

FIG. 11A is a flowchart illustrating the procedure of flick analysis processing (S1011) according to this embodiment.

In step S1101, the screen operation processor 410 acquires whether the flick position within the selected range is a right or left end. In step S1103, the screen operation processor 410 acquires the flick direction. In step S1105, the screen operation processor 410 determines enlargement or reduction of the selected range with reference to the selected range control table 810 based on the flick position and flick direction.

(Selected Range Control Processing)

FIG. 11B is a flowchart illustrating the procedure of selected range control processing (S1013) according to this embodiment.

In step S1111, the screen operation processor 410 determines whether the flick position indicates change of the end (the right end in the case of horizontal writing) of the selected range. If the flick position indicates change of the end of the selected range, the screen operation processor 410 determines enlargement or reduction in step S1113. If enlargement is determined, the screen operation processor 410 enlarges, in step S1115, the end of the selected range rightward by one character. If reduction is determined, the screen operation processor 410 reduces, in step S1117, the end of the selected range leftward by one character.

If it is determined that the flick position indicates no change of the end of the selected range, the screen operation processor 410 determines in step S1121 whether the flick position indicates change of the top (the left end in the case of horizontal writing) of the selected range. If it is determined that the flick position indicates change of the top of the selected range, the screen operation processor 410 determines enlargement or reduction in step S1123. If enlargement is determined, the screen operation processor 410 enlarges, in step S1125, the top of the selected range leftward by one character. If reduction is determined, the screen operation processor 410 reduces, in step S1127, the top of the selected range rightward by one character.

According to this embodiment, since it is possible to change the selected range by one character by a flick at one end of the selected range, and move the selected range by a touch and drag in the central portion of the selected range, it is possible to finely adjust an actually selected target and a target the user wants to select from the display document.

### Third Embodiment

An information processing apparatus according to the third embodiment of the present invention will be described next. The information processing apparatus according to this embodiment is different from that according to the second embodiment in that by performing a long-touch operation in the central portion of a selected range after confirming the selected range, the selected range can be copied or gripped. The remaining components and operations are the same as those in the second embodiment. Hence, the same reference numerals denote the same components and operations, and a detailed description thereof will be omitted.

(User Operation Determiner)

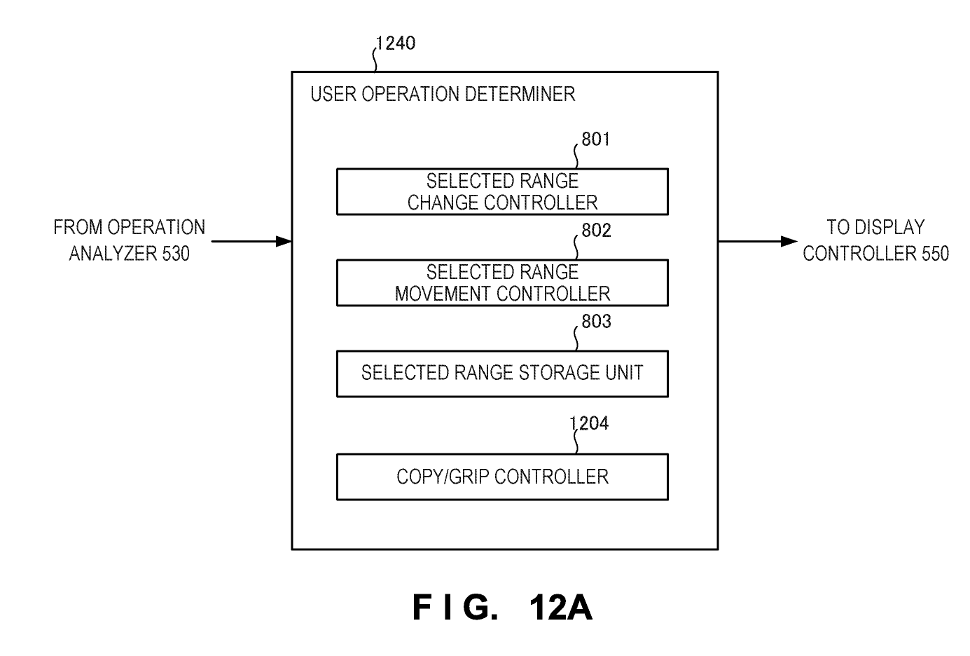

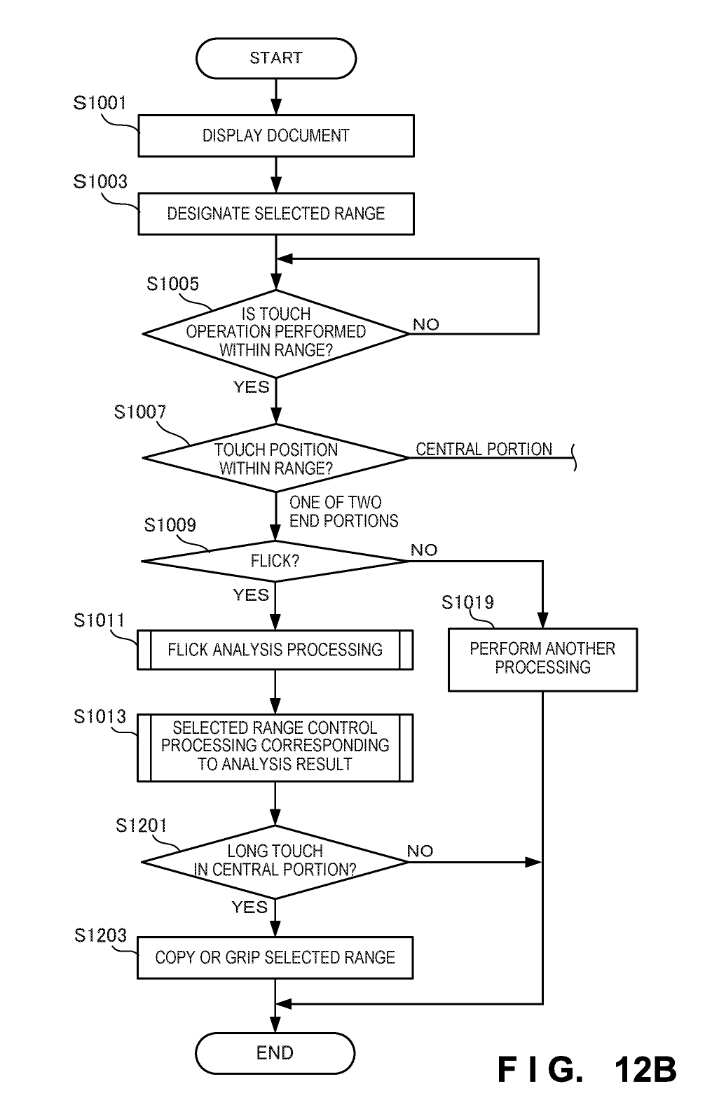

FIG. 12A is a block diagram showing the functional arrangement of a user operation determiner 1240 according to this embodiment. Note that in FIG. 12A, the same reference numerals as in FIG. 8A denote the same functional components and a description thereof will be omitted.

If it is determined that a long touch operation has been performed in the central portion of a selected range after confirming the selected range, a copy/grip controller 1204 shown in FIG. 12A copies or grips the selected range.

<<Procedure of Screen Operation Processing>>

FIG. 12B is a flowchart illustrating the procedure of screen operation processing by an information processing apparatus 200 according to this embodiment. This flowchart implements the respective functional components of a screen operation processor 410 when executed by a processor 400 or the CPU of the screen operation processor 410. A case in which the CPU of the screen operation processor 410 executes the flowchart will be described. Note that in FIG. 12B, the same step numbers as in FIG. 10 denote the same steps and a description thereof will be omitted. FIG. 12B does not illustrate touch and drag processing in the central portion of the selected range.

In step S1201, the screen operation processor 410 determines whether a long-touch operation has been performed in the central portion of the selected range. If it is determined that a long-touch operation has been performed in the central portion of the selected range, the screen operation processor 410 copies or grips the selected range in step S1203.

According to this embodiment, it is possible to continuously perform the operation of associated processing after the range selection without interruption, thereby improving the user operability.

### Fourth Embodiment

An information processing apparatus according to the fourth embodiment of the present invention will be described next. The information processing apparatus according to this embodiment is different from those according to the second and third embodiments in that by performing a long-touch operation in the central portion of a selected range after confirming the selected range, subsequent processing menus are displayed as selection icons for operation selection. The remaining components and operations are the same as those in the second or third embodiment. Hence, the same reference numerals denote the same components and operations, and a detailed description thereof will be omitted.

<<Overview of Processing>>

(Display of Selection Icons)

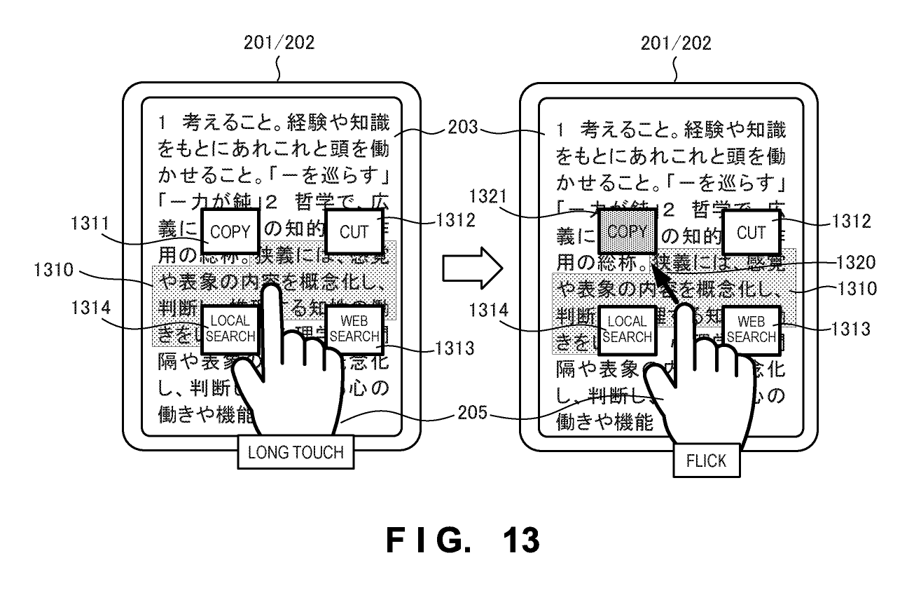

FIG. 13 is a view for explaining display of selection icons in an information processing apparatus 200 according to this embodiment. Note that in FIG. 13, the same reference numerals as in FIGS. 2A and 2B denote the same components and a description thereof will be omitted.

The left view of FIG. 13 shows a state in which a long-touch operation has been performed in the central portion of a selected range 1310 after confirming the selected range 1310. In this case, menus of subsequent processes using a character string within the selected range 1310 appear as selection icons in four directions around a touch position in this embodiment. As the selection icons, for example, “copy”, “cut”, “Web search”, and “local search” are displayed in the upper left and right and lower right and left portions.

The right view of FIG. 13 shows a state in which a flick operation has been performed, with a finger performing a long touch operation, toward the processing menu to be selected. A flick direction 1320 indicates the direction of “copy” in this example, and the character string within the selected range 1310 is copied.

Note that the processing menus are not limited to those in this example. The number of processing menus is not limited to that in this embodiment. The processing menu desirably uses the character string or part of it within the selected range 1310.

(User Operation Determiner)

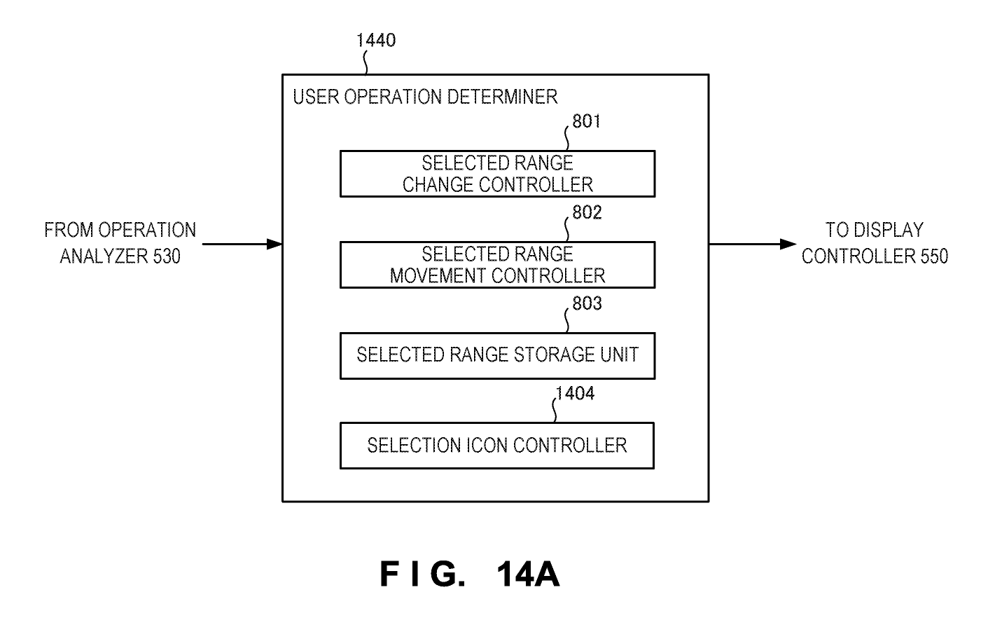

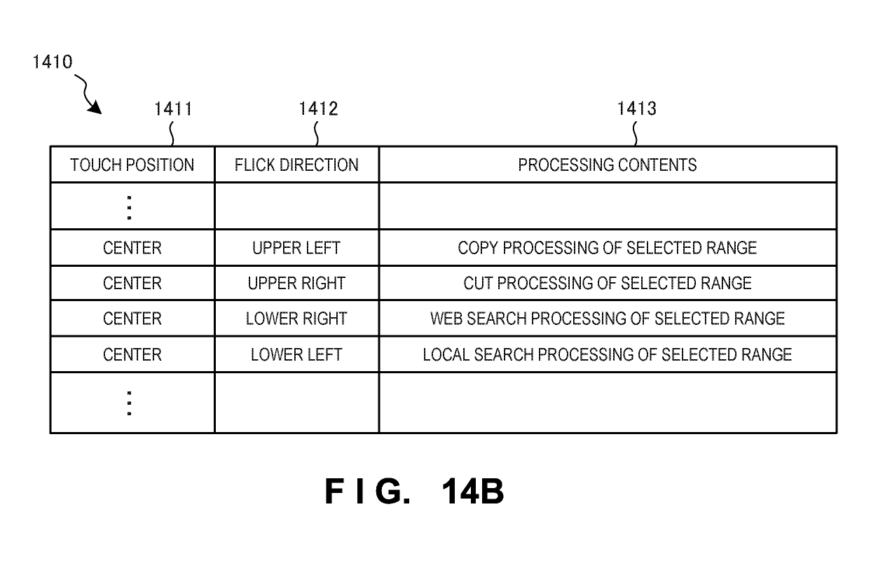

FIG. 14A is a block diagram showing the functional arrangement of a user operation determiner 1440 according to this embodiment. Note that in FIG. 14A, the same reference numerals as in FIG. 8A denote the same functional components and a description thereof will be omitted.

A selection icon controller 1404 shown in FIG. 14A displays, on the screen, selection icons having processing menus associated with the selected range in accordance with a long touch in the central portion of the selected range, and the user selects processing from the processing menus by a flick.

FIG. 14B is a table showing the structure of a selection icon table 1410 according to this embodiment. The selection icon table 1410 is used by the selection icon controller 1404 to select an operation menu by a flick operation after the selection icon controller 1404 displays the selection icons.

The selection icon table 1410 stores processing contents 1413 in association with a touch position 1411 and a flick direction 1412. For example, for the four menus shown in FIG. 13, the copy processing of the selected range is continuously executed by a flick in the upper left direction.

<<Procedure of Screen Operation Processing>>

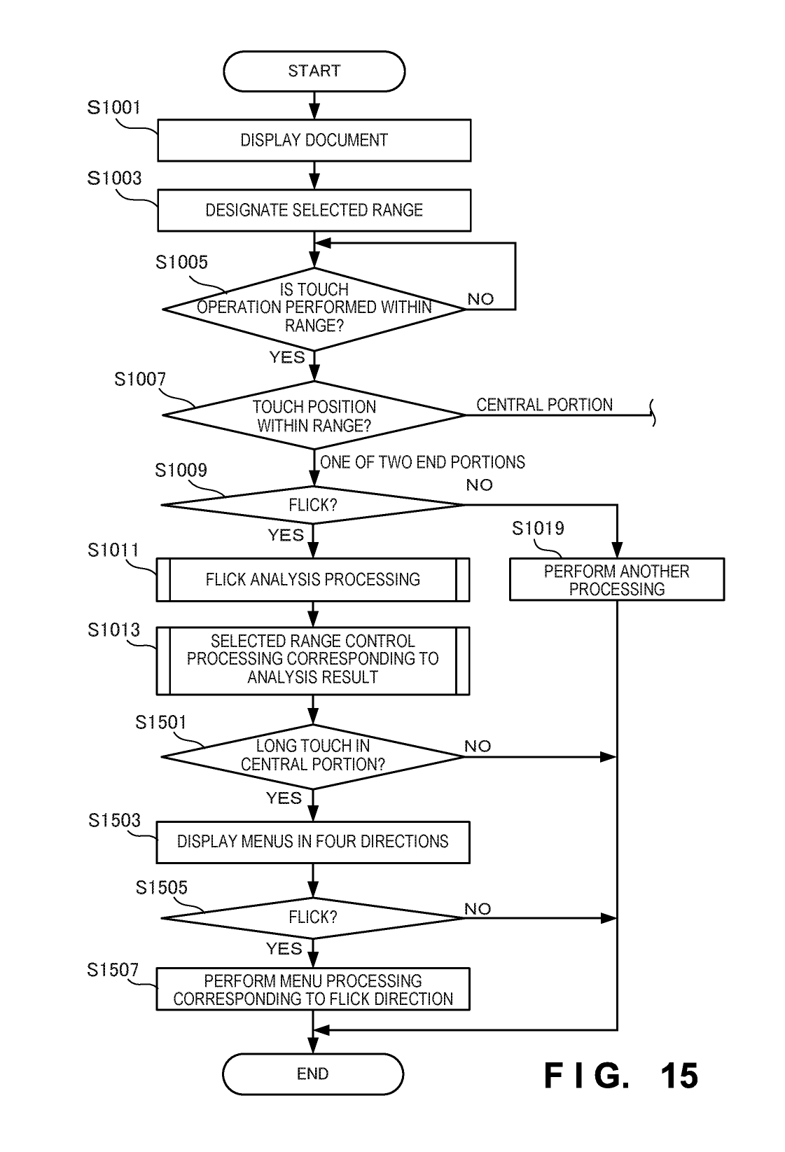

FIG. 15 is a flowchart illustrating the procedure of screen operation processing by the information processing apparatus 200 according to this embodiment. This flowchart implements the respective functional components of a screen operation processor 410 when executed by a processor 400 or the CPU of the screen operation processor 410. A case in which the CPU of the screen operation processor 410 executes the flowchart will be described. Note that in FIG. 15, the same step numbers as in FIG. 10 denote the same steps and a description thereof will be omitted. FIG. 15 does not illustrate touch and drag processing in the central portion of the selected range.

In step S1501, the screen operation processor 410 determines whether a long touch operation has been performed in the central portion of the selected range. If it is determined that a long touch operation has been performed in the central portion of the selected range, the screen operation processor 410 displays menus as selection icons in four directions in step S1503. In step S1505, the screen operation processor 410 determines whether a flick operation has been performed. If it is determined that a flick operation has been performed, in step S1507 the screen operation processor 410 selects a menu corresponding to the flick direction, and performs processing.

According to this embodiment, it is possible to select the operation of associated processing after the range selection, and continuously perform it without interruption, thereby improving the user operability.

### Fifth Embodiment

An information processing apparatus according to the fifth embodiment of the present invention will be described next. The information processing apparatus according to this embodiment is different from those according to the second to fourth embodiments in that a change unit of a selected range can be selected from a plurality of units. For example, as a unit for a document, there are a word, phrase, sentence, paragraph, and the like in addition to a character. The remaining components and operations are the same as those in the second to fourth embodiments. Hence, the same reference numerals denote the same components and operations, and a detailed description thereof will be omitted.

<<Description of Overview>>

(Change of Selected Range)

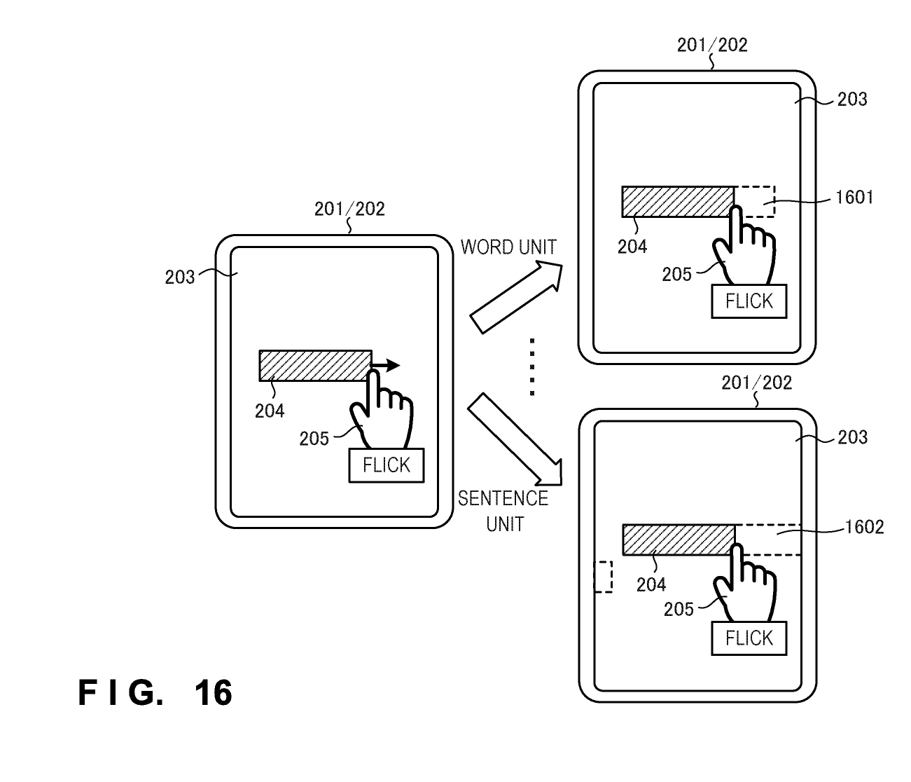

FIG. 16 is a view for explaining change of selected range in the information processing apparatus according to this embodiment. Note that in FIG. 16, the same reference numerals as in FIGS. 2A and 2B denote the same components and a description thereof will be omitted.

The left view of FIG. 16 shows a state in which a user 205 has performed a flick operation at the right end of a selected range 204. The upper right view of FIG. 16 shows an enlargement result when a word unit is set as the enlargement unit of the selected range, in which an enlarged portion 1601 is enlarged from the right end of the selected range 204 to include the next word. On the other hand, the lower right view of FIG. 16 shows an enlargement result when a sentence unit is set as the enlargement unit of the selected range, in which an enlarged portion 1602 is enlarged from the right end of the selected range 204 to include the next sentence.

(User Operation Determiner)

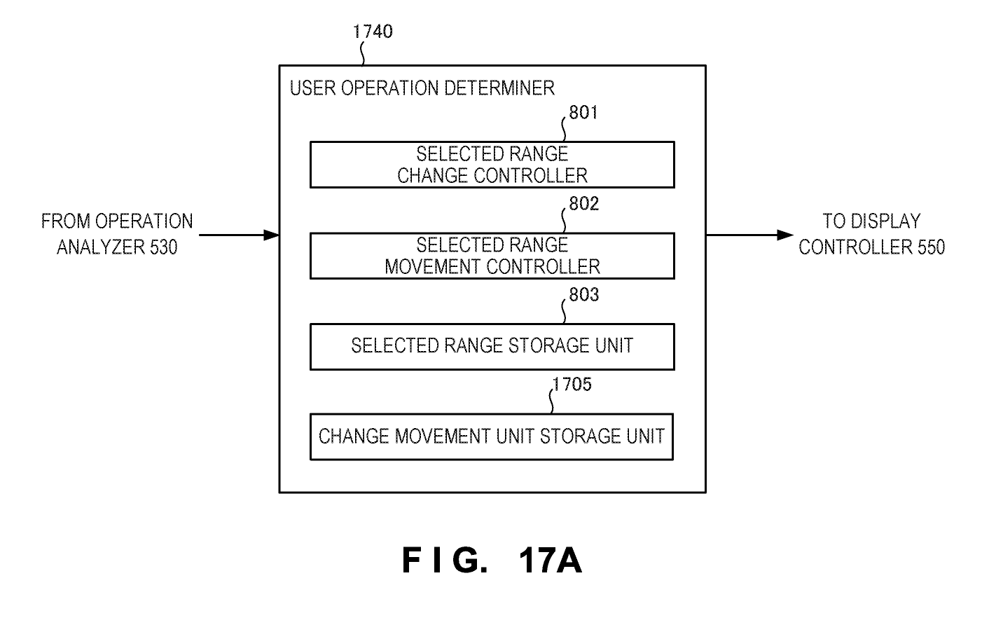

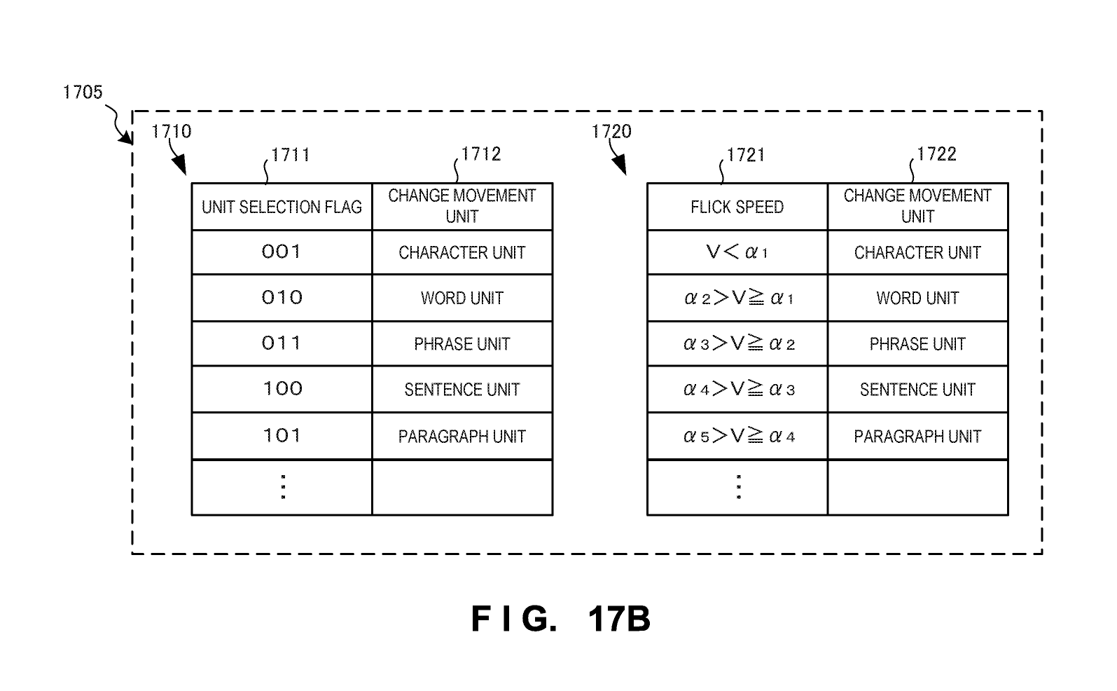

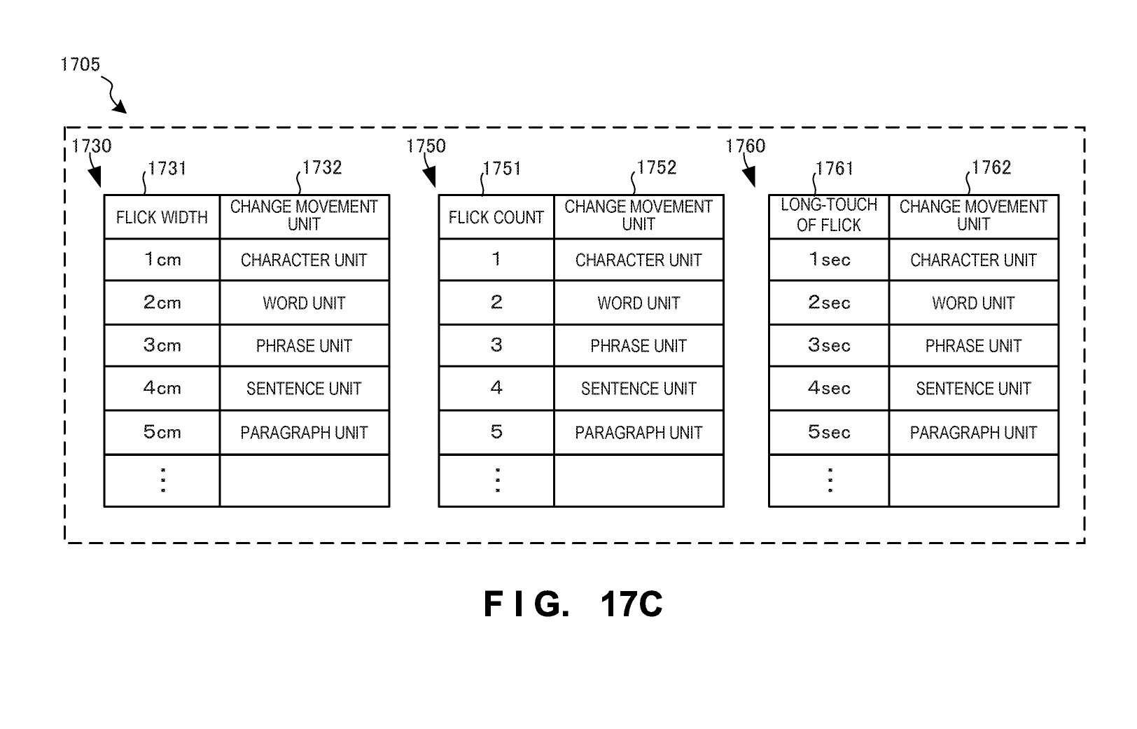

FIG. 17A is a block diagram showing the functional arrangement of a user operation determiner 1740 according to this embodiment. Note that in FIG. 17A, the same reference numerals as in FIG. 8A denote the same functional components and a description thereof will be omitted.

A change movement unit storage unit 1705 shown in FIG. 17A stores a table for selection of various change movement units. A selected range change controller 801 or a selected range movement controller 802 selects a change movement unit using the change movement unit storage unit 1705, and changes or moves the selected range by changing one character in FIG. 8B to the change movement unit.

(Change Movement Unit Storage Unit)

FIGS. 17B and 17C are views showing the arrangement of the change movement unit storage unit 1705 according to this embodiment. Note that FIGS. 17B and 17C show change movement units for a document. However, in the case of another content, units corresponding to the content are selected.

A change movement unit table 1710 stores a change movement unit 1712 in association with a unit selection flag 1711. For example, a character unit, word unit, phrase unit, sentence unit, paragraph unit, and the like are stored in association with the respective unit selection flags 1711.

A change movement unit table 1720 stores a change movement unit 1722 in association with a flick speed 1721. A change movement unit table 1730 stores a change movement unit 1732 in association with a flick width 1731. A change movement unit table 1750 stores a change movement unit 1752 in association with a flick count 1751. A change movement unit table 1760 stores a change movement unit 1762 in association with a long-touch time 1761 of a flick.

According to this embodiment, since the change or movement unit of the selected range can be variously selected, various adjustment operations of the selected range from fine adjustment to rough adjustment are possible, thereby improving the user operability.

### Sixth Embodiment

An information processing apparatus according to the sixth embodiment of the present invention will be described next. The information processing apparatus according to this embodiment is different from those according to the second to fifth embodiments in that enlargement or reduction of a selected range, which changes in accordance with a flick speed, is performed. The remaining components and operations are the same as those in the second to fifth embodiments. Hence, the same reference numerals denote the same components and operations, and a detailed description thereof will be omitted.

(User Operation Determiner)

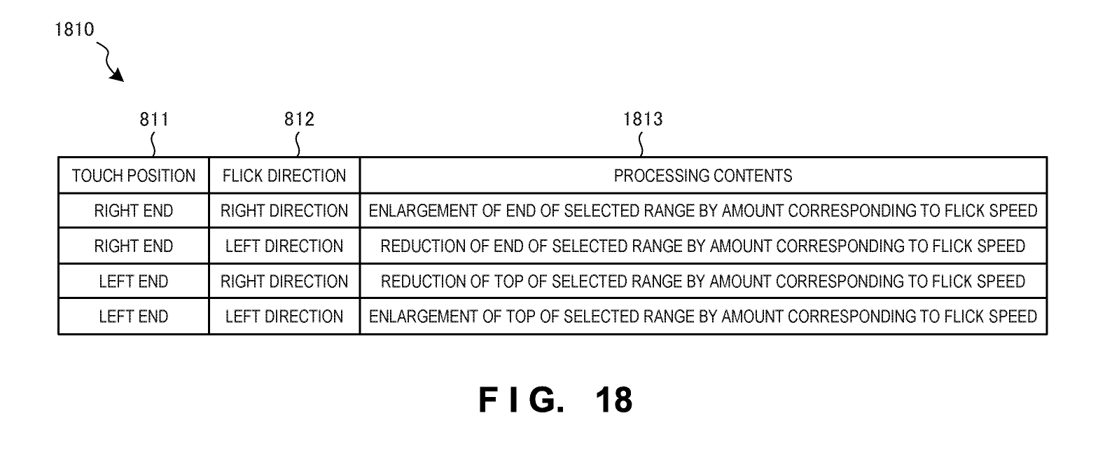

FIG. 18 is a table showing the structure of a selected range control table 1810 according to this embodiment. The selected range control table 1810 is used by a selected range change controller 801 and a selected range movement controller 802 to control a selected range stored in a selected range storage unit 803.

The selected range control table 1810 stores, as processing contents 1813, enlargement or reduction of a selected range by an amount corresponding to a flick speed in association with a touch position 811 within the selected range and a flick direction 812.

According to this embodiment, since the width of enlargement or reduction of the selected range is changed in accordance with a flick speed, processing associated with a flick operation by the user can be implemented.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present invention is applicable to a system including a plurality of devices or a single apparatus. The present invention is also applicable even when an information processing program for implementing the functions of the embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described embodiments.

This application claims the benefit of Japanese Patent Application No. 2014-059242 filed on Mar. 20, 2014, which is hereby incorporated by reference herein in its entirety.

What is claimed is:

1. An information processing apparatus comprising:
a detector that detects a flick in an end portion of a selected range and a touch in a central portion of the selected range while the selected range is displayed in a display region of a touch panel; and
a selected range controller that performs one of enlargement and reduction of the selected range based on the flick, if the detector detects the flick in the end portion, and moves the selected range based on the touch and a drag of the selected range, if the detector detects the touch in the central portion.

2. The information processing apparatus according to claim 1, wherein said selected range controller enlarges the selected range if the flick is in a direction from the inside to the outside of the selected range, and reduces the selected range if the flick is in a direction from the outside to the inside of the selected range.

3. The information processing apparatus according to claim 1, wherein said selected range controller performs one of enlargement and reduction of the selected range in a length unit selected from a plurality of length units.

4. The information processing apparatus according to claim 3, wherein the length unit is selected in accordance with one of a flick width, a flick count, a long touch in a flick, and a flick speed.

5. The information processing apparatus according to claim 1, wherein said detector further detects a touch made for not shorter than a predetermined time in the central portion of the selected range, and
said selected range controller copies a content included in the selected range if the touch made for not shorter than the predetermined time is detected.

6. The information processing apparatus according to claim 1, wherein said detector further detects a touch made for not shorter than a predetermined time in the central portion of the selected range, and
said selected range controller displays icons for selection of operations of a content included in the selected range if the touch made for not shorter than the predetermined time is detected.

7. The information processing apparatus according to claim 6, wherein the icons are icons for selecting whether to copy, cut, or search for the content.

8. The information processing apparatus according to claim 7, wherein the icons are respectively displayed in an upper portion, a lower portion, a right portion, and a left portion around a position of the touch made for not shorter than the predetermined time, and
said selected range controller performs one of a copy operation, a cut operation, and a search operation for the content in accordance with a flick direction from the touch.

9. An information processing method comprising:
detecting a flick in an end portion of a selected range or a touch in a central portion of the selected range while the selected range is displayed in a display region of a touch panel; and
performing one of enlargement and reduction of the selected range based on the flick if the flick is detected in the end portion, and moving the selected range based on the touch and a drag of the selected range if the touch is detected in the central portion.

10. A non-transitory computer-readable storage medium storing an information processing program for causing a computer to execute a method, comprising:
detecting a flick in an end portion of a selected range or a touch in a central portion of the selected range while the selected range is displayed in a display region of a touch panel; and
performing one of enlargement and reduction of the selected range based on the flick if the flick is detected in the end portion, and moving the selected range based on the touch and a drag of the selected range if the touch is detected in the central portion.
